(19) United States
(12) Patent Application Publication
(10) Pub. No.: US 2026/0093728 A1
(43) Pub. Date: Apr. 2, 2026

(54) INFORMATION PROCESSING SYSTEM, INFORMATION PROCESSING METHOD, AND NON-TRANSITORY RECORDING MEDIUM

(71) Applicant: NEC Corporation, Tokyo (JP)

(72) Inventor: Ryosuke WATANABE, Tokyo (JP)

(73) Assignee: NEC Corporation, Tokyo (JP)

(21) Appl. No.: 19/324,532

(22) Filed: Sep. 10, 2025

(30) Foreign Application Priority Data
Sep. 30, 2024 (JP) 2024-170961

(51) Int. Cl. G06F 16/3329; G06F 16/11

(52) U.S. Cl. CPC G06F 16/33295; G06F 16/116

(57) ABSTRACT

An information processing system includes an input information acquisition unit for acquiring input information including a natural language sentence input by a user to obtain a natural language sentence based on a first knowledge in a specific application, a model selection unit for selecting, through decision making, from among one or a plurality of large-scale language models, a tuning model that is a large-scale language model fine-tuned using the second knowledge different from the first knowledge in the specific application, a relevant knowledge acquisition unit for acquiring relevant knowledge relevant to the input information from the first knowledge, and an output information generation unit for generating output information including the natural language sentence corresponding to the relevant knowledge and the input information using the tuning model.

This application is based upon and claims the benefit of priority from Japanese Patent Application No. 2024-170961, filed on Sep. 30, 2024, the disclosure of which is incorporated herein in its entirety by reference.

### TECHNICAL FIELD

The present disclosure relates to an information processing system, an information processing method, and an information processing program.

### BACKGROUND ART

JP 2024-70637 A describes a technique of inputting a text to a natural language processing model and outputting information from a post-stage processing algorithm (classification model, summary model, etc.) connected to a post-stage of the natural language processing model. Furthermore, it is described that the natural language processing model is learned in two stages of preliminary learning and fine-tuning corresponding to a post-stage processing algorithm.

### SUMMARY

Here, fine-tuning described in JP 2024-70637 A is conceivable in order to obtain a highly accurate natural language sentence by a large-scale language model in a specific application such as creation of an assembly reply of a local government. However, there are problems such as entrustment of fine-tuning by an individual user (e.g., for each local government) who wants to obtain a natural language sentence in a specific application is not cost-effective, and performing fine-tuning by himself/herself is difficult in a case where there is no specialized technique. Although retrieval augmented generation (RAG) in which knowledge possessed by an individual user in a specific application is referred to by a general-purpose large-scale language model is also conceivable, there is room for improvement in obtaining a highly accurate natural language sentence adapted to the individual user in the specific application.

The present disclosure has been contrived in view of the above problems, and an exemplary object of the present disclosure is to provide a technique for obtaining a highly accurate natural language sentence adapted to an individual user in a specific application.

An information processing system according to one exemplary aspect of the present disclosure includes an input information acquisition means for acquiring input information including a natural language sentence input by a user to obtain a natural language sentence based on a first knowledge in a specific application, a model selection means for selecting, from one or a plurality of large-scale language models, a tuning model that is a large-scale language model fine-tuned using a second knowledge different from the first knowledge in the specific application, a relevant knowledge acquisition means for acquiring relevant knowledge relevant to the input information from the first knowledge, and an output information generation means for generating output information including a natural language sentence according to the relevant knowledge and the input information by using the tuning model.

An information processing method according to one exemplary aspect of the present disclosure includes an input information acquisition processing in which at least one processor acquires input information including a natural language sentence input by a user to obtain a natural language sentence based on a first knowledge in a specific application, a model selection processing in which the at least one processor selects, from one or a plurality of large-scale language models, a tuning model that is a large-scale language model fine-tuned using a second knowledge different from the first knowledge in the specific application, a relevant knowledge acquisition processing in which the at least one processor acquires relevant knowledge relevant to the input information from the first knowledge, and an output information generation processing in which the at least one processor generates output information including a natural language sentence according to the relevant knowledge and the input information by using the tuning model.

An information processing program according to one exemplary aspect of the present disclosure is a program for causing a computer to function as an information processing system, the information processing program causing the computer to function as an input information acquisition means for acquiring input information including a natural language sentence input by a user to obtain a natural language sentence based on a first knowledge in a specific application, a model selection means for selecting, from one or a plurality of large-scale language models, a tuning model that is a large-scale language model fine-tuned using a second knowledge different from the first knowledge in the specific application, a relevant knowledge acquisition means for acquiring relevant knowledge relevant to the input information from the first knowledge, and an output information generation means for generating output information including a natural language sentence according to the relevant knowledge and the input information by using the tuning model.

According to an exemplary aspect of the present disclosure, there is an exemplary effect that a technique for obtaining a highly accurate natural language sentence adapted to an individual user in a specific application can be provided.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing system according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a block diagram illustrating a functional configuration of an information processing device according to the present disclosure;

FIG. 5 is a block diagram illustrating a configuration of a user terminal according to the present disclosure;

FIG. 6 is a flowchart illustrating a flow of an information processing method according to the present disclosure;

FIG. 7 is a diagram illustrating an example of a model selection screen according to the present disclosure;

FIG. 8 is a diagram illustrating an example of an assembly question input screen according to the present disclosure;

FIG. 9 is a diagram illustrating an example of an assembly reply output screen according to the present disclosure;

FIG. 10 is a flowchart illustrating a flow of an information processing method according to the present disclosure;

FIG. 11 is a diagram schematically illustrating a specific example of conversion processing according to the present disclosure;

FIG. 12 is a flowchart illustrating a flow of an information processing method according to the present disclosure;

FIG. 13 is a diagram illustrating an example of a meeting minutes database management screen according to the present disclosure; and

FIG. 14 is a block diagram illustrating a hardware configuration of a computer that functions as each device according to the present disclosure.

### EXAMPLE EMBODIMENT

Hereinafter, example embodiments of the present disclosure will be described. However, the present disclosure is not limited to the example embodiments to be described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Advantages mentioned in the following example embodiments are examples of advantages expected in the example embodiments, and do not define extensions of the present disclosure. In other words, example embodiments that do not achieve the effects mentioned in the following example embodiments can also be included in the scope of the present disclosure.

### First Example Embodiment

A first example embodiment of the present disclosure will be described in detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technology illustrated in the drawings referred to for describing the present example embodiment can also be adopted in other example embodiments included in the present disclosure within a range in which no particular technical problems occur.

### (Configuration of Information Processing System 1)

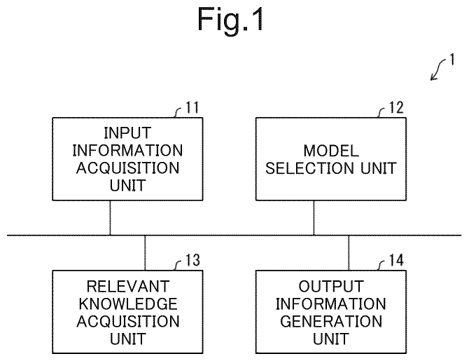

A configuration of the information processing system 1 will be described with reference to FIG. 1. FIG. 1 is a block diagram illustrating the configuration of the information processing system 1. As illustrated in FIG. 1, the information processing system 1 includes an input information acquisition unit 11, a model selection unit 12, a relevant knowledge acquisition unit 13, and an output information generation unit 14. The input information acquisition unit 11 is an example of a configuration that implements an input information acquisition means. The model selection unit 12 is an example of a configuration that implements a model selection means. The relevant knowledge acquisition unit 13 is an example of a configuration that implements a relevant knowledge acquisition means. The output information generation unit 14 is an example of a configuration that implements an output information generation means. These units may be arranged in one computer or may be distributed and arranged in a plurality of computers. In other words, the information processing system 1 may include one computer or may include a plurality of computers.

The input information acquisition unit 11 acquires input information including a natural language sentence input by the user to obtain a natural language sentence based on a first knowledge in a specific application. A specific application is a non-general-purpose application for generating a natural language sentence. Examples of the specific application include, but are not limited to, “creating an assembly reply of a local government”, “creating an answer to a question in an organization of a specific type”, and the like. The organization of a specific type may be, for example, a school, a hospital, a company, or the like, but is not limited thereto.

The first knowledge is knowledge used in a specific application. For example, the first knowledge may be knowledge associated with the user. The user may be an individual or an organization. In a case where the specific application is, for example, “creating an assembly reply of a local government”, the first knowledge may be a record of a past assembly reply in a local government to which the user belongs. Furthermore, in a case where the specific application is, for example, “creating an answer to a question in an organization of a specific type”, the first knowledge may be a record of a past assembly reply in a certain organization of a specific to which the user belongs. However, the first knowledge is not limited thereto.

“Input by the user” may mean that the content itself of the input information is input by the user, or that a file including the input information is designated by the user.

The model selection unit 12 selects a tuning model, that is a fine-tuned large-scale language model using a second knowledge different from the first knowledge in a specific application, from one or a plurality of large-scale language models. Each of the one or a plurality of large-scale language models is a model that can be used by the information processing system 1. The one or the plurality of large-scale language models include one or a plurality of tuning models. The tuning model is a model obtained by fine-tuning a general-purpose large-scale language model using the second knowledge.

The second knowledge is a knowledge used in a specific application and is a knowledge different from the first knowledge. For example, the second knowledge may be a knowledge or the like associated with another user different from the user. In a case where the specific application is, for example, “creating an assembly reply of a local government”, the second knowledge may be a record of a past assembly reply in another local assembly different from the local assembly to which the user belongs. Furthermore, in a case where the specific application is, for example, “creating an answer to a question in an organization of a specific type”, the second knowledge may be a record of past answers in another organization of the specific type different from the organization of a specific type to which the user belongs. However, the second knowledge is not limited thereto.

In addition, some or all of one or a plurality of large-scale language models may be connected to the information processing system 1 via a network or may be included in the information processing system 1. If there is one available large-scale language model, that is, the large-scale language model is a tuning model. In this case, the model selection unit 12 selects the tuning model. If there is a plurality of available large-scale language models, the plurality of large-scale language models include one or a plurality of tuning models. The model selection unit 12 may select, for example, a tuning model designated by a user's operation or may select a tuning model defined in advance from among the plurality of large-scale language models. Furthermore, the model selection unit 12 may select a tuning model corresponding to the input information from among the plurality of large-scale language models.

The relevant knowledge acquisition unit 13 acquires the relevant knowledge relevant to the input information from the first knowledge. For example, the relevant knowledge acquisition unit 13 may acquire, as the relevant knowledge, the knowledge including a keyword included in the input information among the plurality of pieces of knowledge constituting the first knowledge. Furthermore, for example, the relevant knowledge acquisition unit 13 may acquire, as the relevant knowledge, the knowledge in which a similarity with the input information satisfies a predetermined condition among the plurality of pieces of knowledge constituting the first knowledge. However, the method of acquiring the relevant knowledge from the first knowledge is not limited thereto. The first knowledge may be stored in a device connected to the information processing system 1 via a network or may be stored in a device included in the information processing system 1.

The output information generation unit 14 generates output information including a natural language sentence corresponding to the relevant knowledge and the input information by using the tuning model. For example, the output information generation unit 14 inputs the relevant knowledge and the input information to the tuning model. Furthermore, the output information generation unit 14 acquires a natural language sentence output from the tuning model in accordance with the input of the relevant knowledge and the input information. Furthermore, the output information generation unit 14 may generate output information including the acquired natural language sentence. For example, the output information generation unit 14 may include other information in addition to the acquired natural language sentence in the output information. The other information may be, for example, information indicating the referred relevant knowledge, but is not limited thereto. Furthermore, the output information generation unit 14 may output the output information to another device via a network or to an output device.

### (Effects of Information Processing System 1)

As described above, the information processing system 1 adopts a configuration including the input information acquisition unit 11 for acquiring input information including a natural language sentence input by the user to obtain a natural language sentence based on the first knowledge in a specific application, the model selection unit 12 for selecting, from among one or a plurality of large-scale language models, a tuning model that is a large-scale language model fine-tuned using the second knowledge different from the first knowledge in the specific application, the relevant knowledge acquisition unit 13 for acquiring relevant knowledge relevant to the input information from the first knowledge, and the output information generation unit 14 for generating output information including the natural language sentence corresponding to the relevant knowledge and the input information by using the tuning model. Therefore, according to the information processing system 1, in order to obtain a natural language sentence based on the first knowledge in a specific application, a tuning model that has already been fine-tuned using the second knowledge can be used in the same specific application, and fine-tuning using the first knowledge is not required. As a result, an effect is obtained in that a highly accurate natural language sentence adapted to an individual user in a specific application can be obtained.

### (Flow of Information Processing Method S1)

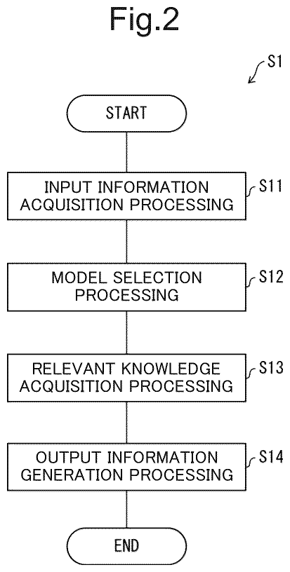

A flow of an information processing method S1 will be described with reference to FIG. 2. For example, in a case where the information processing system 1 includes at least one processor, the at least one processor executes the information processing method S1. FIG. 2 is a flowchart illustrating the flow of the information processing method S1.

As illustrated in FIG. 2, the information processing method S1 includes an input information acquisition processing S11, a model selection processing S12, a relevant knowledge acquisition processing S13, and an output information generation processing S14.

In the input information acquisition processing S11, at least one processor (e.g., the input information acquisition unit 11) acquires input information including a natural language sentence input by the user to obtain the natural language sentence based on the first knowledge in a specific application. Details of the input information acquisition processing S11 are similar to those of the input information acquisition unit 11, and thus description thereof will not be repeated.

In the model selection processing S12, at least one processor (e.g., the model selection unit 12) selects, from among one or a plurality of large-scale language models, a tuning model that is a large-scale language model fine-tuned using second knowledge different from the first knowledge in the specific application. Details of the model selection processing S12 are similar to those of the model selection unit 12, and thus description thereof will not be repeated.

In the relevant knowledge acquisition processing S13, at least one processor (e.g., the relevant knowledge acquisition unit 13) acquires the relevant knowledge relevant to the input information from the first knowledge. Details of the relevant knowledge acquisition processing S13 are similar to those of the relevant knowledge acquisition unit 13, and thus the description thereof will not be repeated.

In the output information generation processing S14, at least one processor (e.g., the output information generation unit 14) generates the output information including the natural language sentence corresponding to the relevant knowledge and the input information by using the tuning model. Details of the output information generation processing S14 are similar to those of the output information generation unit 14, and thus the description thereof will not be repeated.

### (Effects of Information Processing Method S1)

As described above, in the information processing method S1, a configuration is adopted that includes: an input information acquisition processing S11 in which at least one processor acquires input information including a natural language sentence input by a user to obtain a natural language sentence based on the first knowledge in a specific application, a model selection processing S12 in which the at least one processor selects, from among one or a plurality of large-scale language models, a tuning model that is a large-scale language model fine-tuned using second knowledge different from the first knowledge in the specific application, a relevant knowledge acquisition processing S13 in which the at least one processor acquires relevant knowledge relevant to the input information from the first knowledge, and an output information generation processing S14 in which the at least one processor generates output information including the natural language sentence corresponding to the relevant knowledge and the input information by using the tuning model. Therefore, according to the information processing method S1, the same effects as those of the information processing system 1 can be obtained.

### Second Example Embodiment

A second example embodiment of the present disclosure will be described in detail with reference to the drawings. Constituents that have the same functions as the constituents described in the above-described example embodiment are denoted by the same reference numerals, and the description of the constituents will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. Each technique illustrated in each of the drawings referred to for describing the present example embodiment can be employed in the other example embodiments included in the present disclosure within a range in which no particular technical problem occurs.

### (Outline of Information Processing System 1A)

An information processing system 1A is a system that provides a service for creating a natural language sentence in a specific application. In the present example embodiment, an example in which a specific application is an application for creating an assembly reply of a local government will be centrally described. Hereinafter, the service for creating an assembly reply is also referred to as an assembly reply creating service. The local government to which the user who uses the assembly reply creating service is related is also referred to as a first local government. In other words, the user is a person related to the first local government (e.g., a staff member etc.). Hereinafter, the user may be simply referred to as a first local government.

In addition, the input information input to the assembly reply creating service includes a natural language sentence indicating an assembly question. Furthermore, the output information generated by the assembly reply creating service includes a natural language sentence indicating an assembly reply. Moreover, in the assembly reply creating service, the first knowledge is referred to in order to generate an assembly reply. The first knowledge is a knowledge related to the past assembly reply in the first local government. In addition, a large-scale language model (hereinafter referred to as a tuning model) fine-tuned using the second knowledge is used to generate an assembly reply. The second knowledge is a knowledge related to the past assembly reply in a second local government different from the first local government. In other words, the second local government is a local government that provides the second knowledge for generating the tuning model. The number of each of the first local government and the second local government is not limited to one, and may be plural. Furthermore, the information processing system 1A may provide a service for creating a natural language sentence in another specific application in addition to the assembly reply creating service.

### (Configuration of Information Processing System 1A)

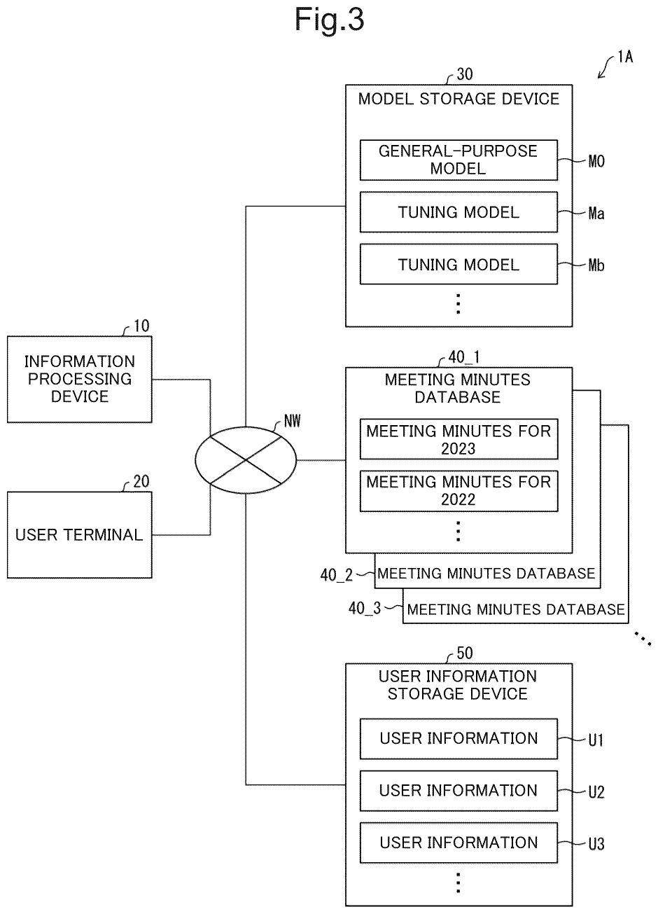

A configuration of the information processing system 1A will be described with reference to FIG. 3. FIG. 3 is a block diagram illustrating a configuration of the information processing system 1A. The information processing system 1A includes an information processing device 10, a user terminal 20, a model storage device 30, meeting minutes databases 40_1, 40_2, 40_3, . . . , and a user information storage device 50. Each of the meeting minutes databases 40_1, 40_2, 40_3, . . . is simply described as the meeting minutes database 40 in a case where it is not necessary to particularly distinguish the meeting minutes databases. The information processing device 10 is communicably connected to each of the user terminal 20, the model storage device 30, the meeting minutes database 40, and the user information storage device 50 via a network NW. The network NW may include a wireless local area network (LAN), a wired LAN, a wide area network (WAN), a public network, a mobile data communication network, or a combination of some or all of the same, but is not limited thereto. The functional configurations of the information processing device 10 and the user terminal 20 will be described later with reference to a different drawing.

### (Model Storage Device 30)

The model storage device 30 stores a plurality of large-scale language models. The plurality of large-scale language models includes a general-purpose model M0, a tuning model Ma, and a tuning model Mb. The general-purpose model M0 is a general-purpose large-scale language model. Although one general-purpose model M0 is illustrated in FIG. 3, the number of general-purpose models stored in the model storage device 30 is not limited, and the number may be plural. Furthermore, the general-purpose model M0 is not limited to being stored in the model storage device 30, and may be stored in a device outside the information processing system 1A.

The tuning model Ma is a large-scale language model fine-tuned for the application of creating an assembly reply for an assembly question. The past meeting minutes (an example of the second knowledge) in the second local government are used for fine-tuning of the tuning model Ma. The tuning model Mb is a large-scale language model fine-tuned for the application of creating an answer to a question in the office. An in-office Q&A (an example of the second knowledge) in the second local government is used for fine-tuning of the tuning model Mb.

The “second local government” related to the past meeting minutes used for fine-tuning of the tuning model Ma and the “second local government” related to the in-office Q&A used for fine-tuning of the tuning model Mb may be the same or different. In addition, although two tuning models Ma and Mb are illustrated in FIG. 3, the number of tuning models stored in the model storage device 30 is not limited, and the number may be one or three or more. Furthermore, although FIG. 3 illustrates one tuning model Ma and Mb for each specific application, the number of tuning models fine-tuned in a certain specific application is not limited, and the number may be one or three or more. For example, in the application of creating the assembly reply, a plurality of tuning models fine-tuned by using meeting minutes of a plurality of different second local governments, respectively, may be stored. In addition, in the application of creating the assembly reply, a plurality of tuning models fine-tuned using a plurality of meeting minutes having different periods at least in part regarding the same second local government may be stored.

### (Meeting Minutes Database 40)

The meeting minutes database 40 stores meeting minutes associated with the first local government for each first local government using the information processing system 1A. The meeting minute is an example of the first knowledge. For example, the meeting minutes database 40_1 stores the meeting minutes of the assembly in 2023, the meeting minutes of the assembly in 2022, . . . of the local government L1 (an example of the first local government). Furthermore, for example, the meeting minutes database 40_2 stores the meeting minutes of the assembly in 2023, the meeting minutes of the assembly in 2022, . . . of the local government L2 (an example of the first local government). Moreover, for example, the meeting minutes database 40_3 stores the meeting minutes of the assembly in 2023, the meeting minutes of the assembly in 2022, . . . of the local government L3 (an example of the first local government). Although FIG. 3 illustrates the three meeting minutes databases 40_1 to 40_3, the number of meeting minutes databases 40 included in the information processing system 1A is not limited, and the number may be 1, 2, or 4 or more.

### (User Information Storage Device 50)

The user information storage device 50 stores user information regarding a user who uses the information processing system 1A. For example, the user information U1 indicates information regarding the local government L1. Furthermore, for example, the user information U2 indicates information regarding the local government L2. Moreover, for example, the user information U3 indicates information regarding the local government L3. Each piece of user information U1 to U3 may include user identification information (e.g., information for identifying the first local government) for identifying the user. Furthermore, each piece of user information U1 to U3 may include, for example, information indicating the type of contract.

The type of contract indicates the type of usage contract of a service between the provider who provides the assembly reply creating service and the first local government. The type of contract may be, for example, a type corresponding to the magnitude of consideration required to use the assembly reply creating service to use the service. Examples of the type of contract include a free member, a first paying member that pays a first usage fee, and a second paying member that pays a second usage fee higher than the first usage fee, but the type and the number of types of the contract are not limited thereto.

Although three pieces of user information U1 to U3 are illustrated in FIG. 3, the number of pieces of user information stored in the user information storage device 50 is not limited, and the number may be 1, 2, or 4 or more. In addition, each of the local governments L1 to L3 (an example of the first local government) using the information processing system 1A may be the same as or different from the second local government related to the second knowledge used for fine-tuning of the tuning model Ma or Mb. In other words, the second local government may also be able to use the information processing system 1A as the user.

### (Information Processing Device 10)

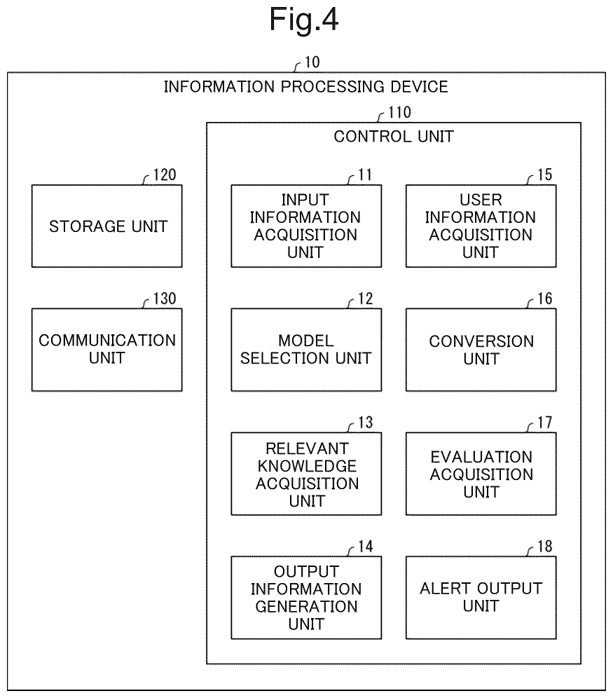

The configuration of the information processing device 10 will be described with reference to FIG. 4. FIG. 4 is a block diagram illustrating a functional configuration of the information processing device 10. As illustrated in FIG. 4, the information processing device 10 includes a control unit 110, a storage unit 120, and a communication unit 130. The control unit 110 integrally controls each unit of the information processing device 10. The storage unit 120 stores various types of information referred to by the control unit 110. The communication unit 130 communicates with a device (e.g., the user terminal 20, the model storage device 30, the meeting minutes database 40, the user information storage device 50, etc.) outside the information processing device 10 via a communication line NW. The communication unit 130 transmits data supplied from the control unit 110 to another device, and supplies data received from another device to the control unit 110.

### (Functional Block Included in Control Unit 110)

The control unit 110 includes a user information acquisition unit 15, a conversion unit 16, an evaluation acquisition unit 17, and an alert output unit 18 in addition to the input information acquisition unit 11, the model selection unit 12, the relevant knowledge acquisition unit 13, and the output information generation unit 14 included in the information processing system 1. The user information acquisition unit 15 is an example of a configuration that implements a user information acquisition means. The conversion unit 16 is an example of a configuration that implements a conversion means. The evaluation acquisition unit 17 is an example of a configuration that implements an evaluation means. The alert output unit 18 is an example of a configuration that implements an alert output means.

The input information acquisition unit 11 is configured as follows in addition to being configured similar to that in the first example embodiment. The input information acquisition unit 11 acquires input information including a natural language sentence indicating an assembly question input by the user. Furthermore, the input information acquisition unit 11 may acquire user identification information for identifying the user who inputs the input information. The user identification information is information for identifying the user, and includes, for example, information for identifying the first local government to which the user belongs.

The user information acquisition unit 15 acquires user information regarding the user. A specific example of the user information is as described above. For example, in a case where the input information acquisition unit 11 acquires the user identification information together with the input information, the user information acquisition unit 15 may acquire the user information including the user identification information from the user information storage device 50.

The model selection unit 12 is configured as follows in addition to being configured similar to that in the first example embodiment. The model selection unit 12 changes a selectable large-scale language model among the plurality of large-scale language models according to the user information. For example, in a case where the user information includes information indicating the type of contract, the model selection unit 12 may change the selectable large-scale language model according to the type of contract. As a result, the user can use an appropriate large-scale language model corresponding to the type of contract.

For example, in a case where the type of contract is provided according to the magnitude of the consideration for using the service, “changing the selectable large-scale language model” may mean that more large-scale language models can be selected the larger the consideration. In addition, “changing the selectable large-scale language model” may mean that a large-scale language model in which the extent of being adapted to a specific application is high can be selected the larger the consideration. For example, it can be said that the tuning model Ma or Mb has a higher degree of being adapted to a specific application than the general-purpose model M0. Therefore, as an example, the free member can select only the general-purpose model M0, and the paying member can select the general-purpose model M0 and the tuning models Ma and Mb. As a result, an appropriate large-scale language model according to the type of contract can be used for a user who wishes to select a desired model from among more large-scale language models or large-scale language models having a higher degree of being adapted to a specific application.

The conversion unit 16 converts the data format of the first knowledge. For example, the conversion unit 16 may convert the first knowledge recorded in the natural language sentence into the first knowledge including a set of predetermined items. For example, the conversion unit 16 may convert the meeting minute recorded in the natural language sentence into a meeting minute including a set of assembly question and assembly reply. However, the data format before and after the conversion is not limited to the example described above. As a result, the first knowledge can be in a data format suitable for acquisition of relevant knowledge to be described later.

The output information generation unit 14 is configured as follows in addition to being configured similar to that in the first example embodiment. The output information generation unit 14 includes information indicating the relevant knowledge in the output information. For example, the information indicating the relevant knowledge to be included in the output information may be an outline such as a title of the relevant knowledge. This allows the user to know what kind of relevant knowledge the large-scale language model has referred to when creating an assembly reply corresponding to an assembly question.

The evaluation acquisition unit 17 acquires the evaluation of the user with respect to the relevant knowledge included in the output information. For example, the evaluation may be information indicating the appropriateness as a reference destination in a plurality of stages, but is not limited thereto. Furthermore, for example, the evaluation acquisition unit 17 may store the acquired evaluation in association with the relevant knowledge. Specifically, the evaluation acquisition unit 17 may store the evaluation in association with the knowledge acquired as the relevant knowledge in the meeting minutes in the meeting minutes database 40. As a result, the evaluation can be referred to in the next and subsequent relevant knowledge acquisition processing.

The relevant knowledge acquisition unit 13 is configured as follows in addition to being configured similar to that in the first example embodiment. The relevant knowledge acquisition unit 13 acquires the relevant knowledge relevant to the input information from the converted first knowledge. For example, the relevant knowledge acquisition unit 13 may extract a keyword from the input information and acquire meeting minutes including an item similar to the keyword in the converted first knowledge as the relevant knowledge. As a result, the relevant knowledge relevant to the input information can be more easily acquired from the first knowledge.

Furthermore, the relevant knowledge acquisition unit 13 acquires relevant knowledge relevant to new input information based on the first knowledge and the evaluation. For example, the relevant knowledge acquisition unit 13 may acquire the knowledge, to which the evaluation satisfying a predetermined condition is associated, from the meeting minutes database 40 in order to acquire the relevant knowledge relevant to the new input information. As a result, the knowledge in the meeting minutes in which the evaluation by the user satisfies the predetermined condition (e.g., evaluated as “good”) can be acquired as the relevant knowledge. In addition, with this configuration, it is possible to prevent acquisition of the knowledge in the meeting minutes in which the evaluation by the user does not satisfy the predetermined condition (e.g., evaluated as “bad”) as the relevant knowledge.

The alert output unit 18 outputs an alert regarding knowledge satisfying a predetermined alert condition among each of the knowledge constituting the first knowledge. For example, it is assumed that date and time information is associated with each knowledge constituting meeting minutes in the meeting minutes database 40. The date and time information may be a held date and time of assembly, a registration date and time or an update date and time of the knowledge, or the like. In this case, the alert condition may be a condition related to date and time. For example, the alert condition may be that the date and time indicated by the date and time information is earlier than the present by a predetermined period or more (e.g., three or more years ago). As a result, an alert can be output for knowledge that is not appropriate to be referred to by a large-scale language model as relevant knowledge (e.g., old knowledge). The alert condition is not limited to the example described above.

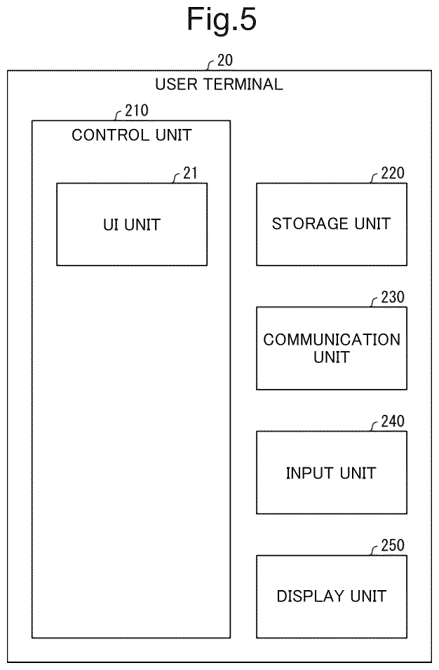

(Configuration of User Terminal 20) FIG. 5 is a block diagram illustrating a configuration of the user terminal 20. As illustrated in FIG. 5, the user terminal 20 includes a control unit 210, a storage unit 220, a communication unit 230, an input unit 240, and a display unit 250. The control unit 210 integrally controls each unit of the user terminal 20. The storage unit 220 stores various types of information referred to by the control unit 210. The communication unit 230 communicates with a device (e.g., the information processing device 10 etc.) outside the user terminal 20 via a communication line NW. The communication unit 230 transmits data supplied from the control unit 210 to another device, and supplies data received from another device to the control unit 210.

The input unit 240 is a configuration for accepting an input to the user terminal 20, and may include an input device such as a keyboard, a mouse, a touch panel, a camera, or a microphone as an example. The display unit 250 is a configuration for displaying a screen output from the user terminal 20, and may include a display as an example. Furthermore, the input unit 240 and the display unit 250 may be integrally formed as a touch panel or the like. In addition, one or both of the input unit 240 and the display unit 250 are not limited to being built in the user terminal 20, and may be connected to the outside via an interface such as, for example, a Universal Serial Bus (USB).

The control unit 210 includes a User Interface (UI) unit 21. The UI unit 21 provides a user interface for using a service for creating a natural language sentence in a specific application. For example, the UI unit 21 accepts a user's operation for using the service and transmits the operation to the information processing device 10. Furthermore, upon receiving a screen related to the service from the information processing device 10, the UI unit 21 displays the received screen on the display unit 250. For example, the UI unit 21 may be achieved by executing an application program for using the service stored in the storage unit 220. The application program may be an application dedicated to the service. Furthermore, in a case where the service is implemented as a web service, the application program may be a general-purpose web browser.

### (Flow of Information Processing Method S1A)

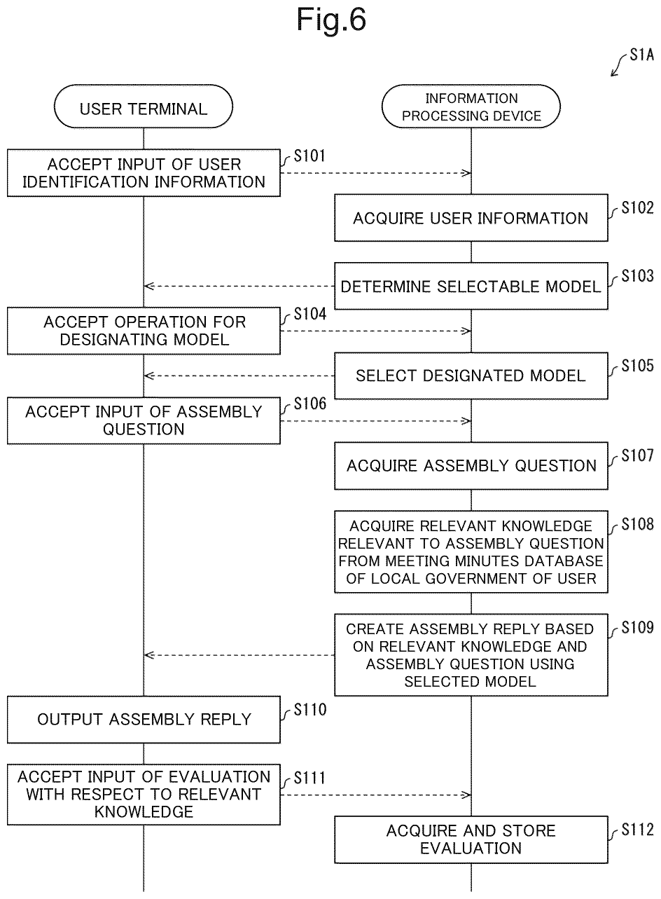

The information processing system 1A configured as described above executes the information processing method S1A. FIG. 6 is a flowchart illustrating the flow of the information processing method S1A. As illustrated in FIG. 6, the information processing method S1A includes steps S101 to S112.

In step S101, the UI unit 21 of the user terminal 20 accepts an operation for inputting user identification information. For example, the user identification information may be given to the first local government or a related party to the first local government in the contract for using the assembly reply creating service. As described above, the user identification information includes, for example, information for identifying the first local government. The input information acquisition unit 11 transmits the input user identification information to the information processing device 10.

In step S102, the input information acquisition unit 11 of the information processing device 10 receives the user identification information. In addition, the input information acquisition unit 11 specifies the user information including the received user identification information among the user information stored in the user information storage device 50.

In step S103, the model selection unit 12 changes the selectable model among the plurality of large-scale language models according to the user information. In addition, the model selection unit 12 transmits information indicating the selectable models to the user terminal 20.

For example, as described above, the model selection unit 12 may change the selectable model according to the type of contract included in the user information. For example, an example in which the type of contract is any of the free member, the first paying member, and the second paying member described above will be described. In this case, the free member may select only the general-purpose model M0, the first paying member may select the general-purpose model M0 or the tuning model Ma, and the second paying member may select any of the general-purpose model M0 and the tuning models Ma and Mb.

In step S104, the UI unit 21 of the user terminal 20 presents a selectable model to the user and accepts an operation for designating any of the presented models. The UI unit 21 transmits information indicating the designated model to the information processing device 10.

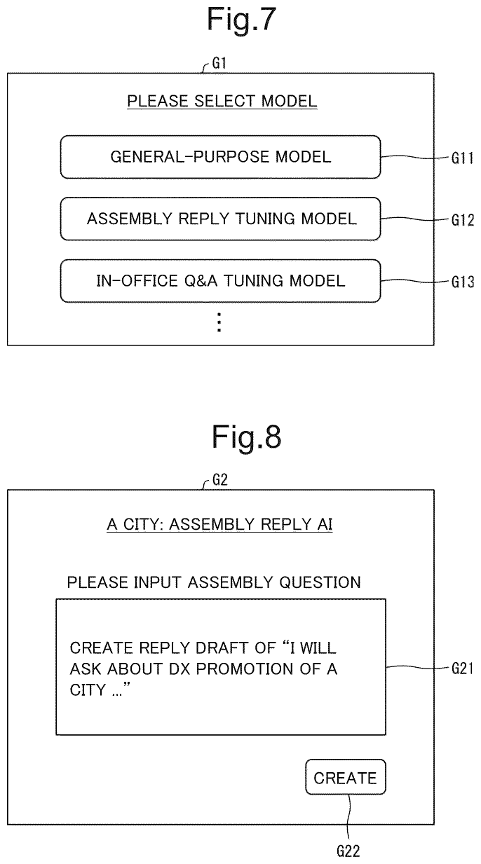

FIG. 7 is a diagram illustrating an example of a model selection screen displayed on the display unit 250 of the user terminal 20 in step S104. As illustrated in FIG. 7, a screen example G1 includes operation objects G11 to G13 corresponding to each of the selectable models. The operation object G11 accepts an operation for designating the general-purpose model M0. The operation object G12 accepts an operation for designating the tuning model Ma for creating an assembly reply. The operation object G13 accepts an operation for designating the tuning model Mb for creating an in-office Q&A. That is, in the screen example G1, the selectable models are the general-purpose model M0, the tuning model Ma, and the tuning model Mb.

Step S105 is an example of the model selection processing. In step S105, the model selection unit 12 of the information processing device 10 selects the model designated by the user in the user terminal 20 from among the plurality of large-scale language models stored in the model storage device 30. Furthermore, the information processing device 10 transmits an input screen corresponding to the selected model to the user terminal 20. For example, in a case where the tuning model Ma for creating an assembly reply is selected, an input screen for inputting an assembly question is transmitted to the user terminal 20.

In step S106, the UI unit 21 of the user terminal 20 accepts an operation for inputting input information including a natural language sentence indicating the assembly question. Furthermore, the UI unit 21 transmits the input information to the information processing device 10.

FIG. 8 is a diagram illustrating an example of an assembly question input screen displayed on the display unit 250 of the user terminal 20 in step S106. As illustrated in FIG. 8, the screen example G2 is displayed in a case where the tuning model Ma for creating the assembly reply is designated by a user who is a related party of “A city” serving as an example of the first local government. The screen example G2 includes an input area G21 and an operation object G22. The input area G21 accepts an input of a natural language sentence indicating an assembly question. Here, a natural language sentence indicating an assembly question “I will ask about DX promotion of A city . . . ” and a natural language sentence indicating a command of “create a reply draft of . . . ” are input. The operation object G22 accepts an operation for instructing creation of an assembly reply.

Step S107 is an example of the input information acquisition processing. In step S107, the input information acquisition unit 11 of the information processing device 10 acquires the input information input by the user to the user terminal 20. The acquired input information includes a natural language sentence indicating an assembly question.

Step S108 is an example of the relevant knowledge acquisition processing. In step S108, the relevant knowledge acquisition unit 13 acquires, from the meeting minutes database 40 corresponding to the first local government related to the user, the relevant knowledge relevant to the assembly question included in the input information. Here, for example, the meeting minutes stored in the meeting minutes database 40 may be meeting minutes after conversion in which a data format is converted by the conversion unit 16. A detailed specific example of the conversion processing will be described later with reference to a different drawing.

Furthermore, in a case where the evaluation is associated with the knowledge constituting the meeting minutes in the meeting minutes database 40, the relevant knowledge acquisition unit 13 may acquire the relevant knowledge relevant to the input information from the knowledge in which the evaluation satisfies a predetermined condition among the knowledge constituting the meeting minutes.

Step S109 is an example of the output information generation processing. In step S109, the output information generation unit 14 refers to the input information and the relevant knowledge, and generates the output information using the selected model. For example, the output information generation unit 14 inputs the input information including a natural language sentence indicating an assembly question and the relevant knowledge relevant to the assembly question acquired from the meeting minutes database 40 to the tuning model Ma for creating an assembly reply. As a result, a natural language sentence indicating the assembly reply is output from the tuning model Ma. In addition, the output information generation unit 14 generates output information including the natural language sentence indicating the assembly reply and the information indicating the referred relevant knowledge. In addition, the output information generation unit 14 transmits an output screen including the output information to the user terminal 20.

In step S110, the UI unit 21 of the user terminal 20 displays the received output screen on the display unit 250. As a result, the output information including the generated assembly reply and the referred relevant knowledge is presented to the user.

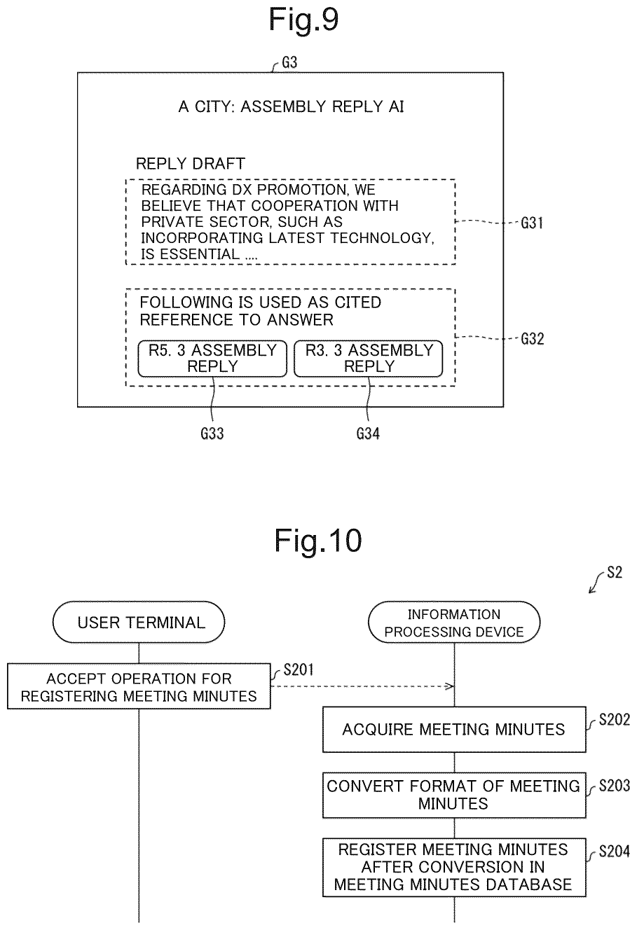

FIG. 9 is a diagram illustrating an example of an assembly reply output screen displayed on the display unit 250 of the user terminal 20 in step S110. As illustrated in FIG. 9, the screen example G3 is output in response to the operation on the operation object G22 in the screen example G2. The screen example G3 includes regions G31 and G32 and operation objects G33 and G34. The region G31 includes a natural language sentence “regarding the DX promotion, we believe that cooperation with the private sector, such as incorporating the latest technology, is essential.” indicating the generated assembly reply. As a result, the user can consider the actual assembly reply based on the assembly reply of the region G31.

Furthermore, the region G32 includes an operation object G33 corresponding to “R5.3 (March 2023) assembly reply” and an operation object G34 corresponding to “R3.3 (March 2021) assembly reply” indicating the referred relevant knowledge. Each of the operation objects G33 and G34 may accept an operation for instructing display of a detailed screen (not illustrated) of the corresponding relevant knowledge. As a result, the user can consider the fact that the assembly reply in the region G31 is generated with reference to the relevant knowledge in the region G32, and then, consider the actual assembly reply based on the assembly reply.

In step S111, the UI unit 21 accepts an operation for inputting the evaluation with respect to the relevant knowledge. For example, the UI unit 21 may accept an operation for inputting evaluation in a plurality of stages (e.g., two stages of “good” or “bad”) with respect to the relevant knowledge. Furthermore, for example, the operation object that accepts the evaluation may be included in the detailed screen of the corresponding relevant knowledge displayed according to the operation on the operation object G33 or G34 in the screen example G3. The UI unit 21 transmits information indicating the input evaluation to the information processing device 10.

In step S112, the evaluation acquisition unit 17 of the information processing device 10 acquires information indicating the evaluation with respect to the relevant knowledge input in the user terminal 20. In addition, the evaluation acquisition unit 17 stores the acquired information indicating the evaluation in the meeting minutes database 40 in association with the knowledge corresponding to the corresponding relevant knowledge. The stored evaluation may be referred to in the relevant knowledge acquisition processing of step S108 when the information processing method S1A is executed next time or later.

### (Flow of Information Processing Method S2)

The meeting minutes referred to in the relevant knowledge acquisition processing in step S108 described above may be meeting minutes after conversion in which a data format is converted. The information processing system 1A may execute an information processing method S2 for converting a data format of the meeting minutes. FIG. 10 is a flowchart illustrating the flow of the information processing method S2. As illustrated in FIG. 10, the information processing method S2 includes steps S201 to S204.

In step S201, the UI unit 21 of the user terminal 20 accepts an operation for registering the meeting minutes. The operation may be an operation for inputting the meeting minutes themselves or an operation for designating a file in which the meeting minutes are recorded. The user who performs the operation may be, for example, the same as or different from the user who can use the meeting minutes creating service.

For example, the operation for registering the meeting minutes may be accepted by inputting the user identification information to which the authority to register the meeting minutes is given. The UI unit 21 transmits the meeting minutes to the information processing device 10.

In step S202, the conversion unit 16 of the information processing device 10 acquires the meeting minutes input in the user terminal 20.

Step S203 is an example of the conversion processing. In step S203, the conversion unit 16 converts the data format of the acquired meeting minutes. For example, the conversion unit 16 may convert the meeting minutes into a data format represented by a combination of predetermined items.

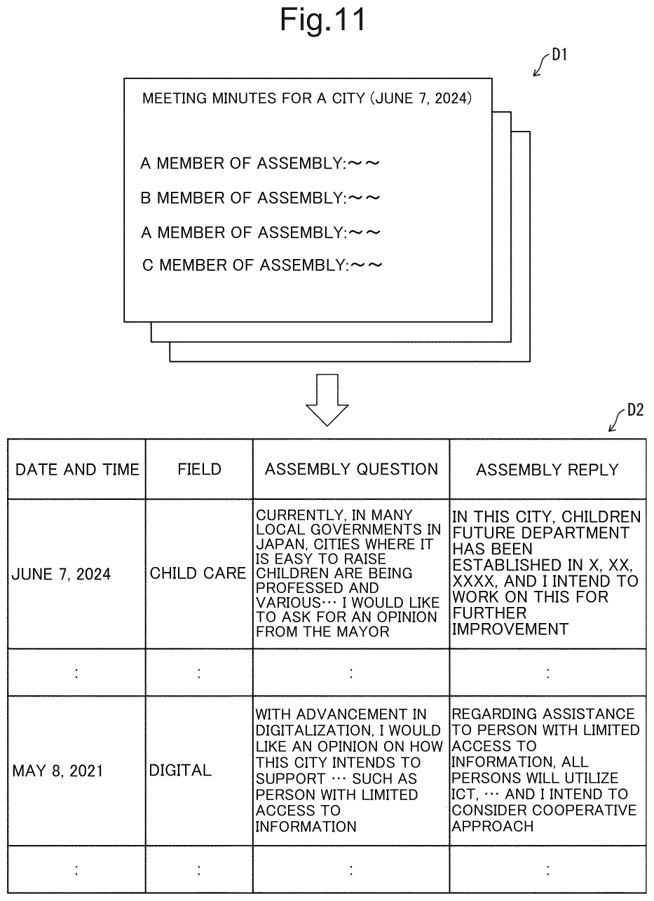

FIG. 11 is a diagram schematically illustrating a specific example of the conversion processing. In FIG. 11, meeting minutes D1 indicate meeting minutes at the A city council on Jun. 7, 2024, and are in a data format of a natural language sentence in which statements of each member of the council are recorded in chronological order. By analyzing the meeting minutes D1, the conversion unit 16 converts the meeting minutes D1 into meeting minutes D2 in a data format represented by a combination of items of a date and time, a field, an assembly question, and an assembly reply. By referring to the meeting minutes D2 after the conversion, for example, in a case where a keyword related to a field such as “child care” is included in the input assembly question, relevant knowledge can be acquired from a set of assembly question and assembly reply in which the field is “child care”. This has an advantage that the appropriateness of the relevant knowledge is improved and the calculation cost for searching for the relevant knowledge is reduced.

### (Flow of Information Processing Method S3)

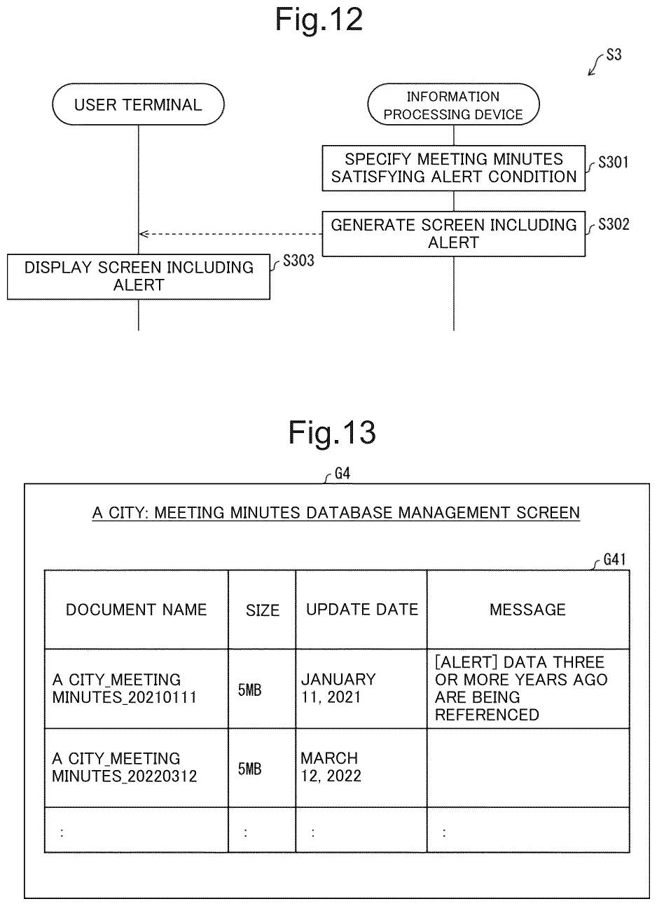

The information processing system 1A may execute an information processing method S3 for outputting an alert for meeting minutes. For example, the information processing method S3 may be executed in response to an operation in which the user accesses a screen for managing the meeting minutes. The user who performs the operation may be, for example, the same as or different from the user who can use the meeting minutes creating service. For example, the operation for managing the meeting minutes may be accepted by inputting user identification information to which the authority to manage the meeting minutes is given. FIG. 12 is a flowchart illustrating the flow of the information processing method S3. As illustrated in FIG. 12, the information processing method S3 includes steps S301 to S303.

In step S301, the alert output unit 18 of the information processing device 10 specifies the knowledge satisfying the alert condition among the knowledge constituting the meeting minutes stored in the meeting minutes database 40. For example, as described above, the alert output unit 18 may specify knowledge whose associated date and time information satisfies a predetermined condition (e.g., a predetermined period or more before the present time).

In step S302, the alert output unit 18 generates a screen including an alert.

For example, the alert output unit 18 may generate a screen including a list of knowledge constituting the meeting minutes, and add information indicating the alert to the knowledge satisfying the alert condition among the knowledge. In addition, the alert output unit 18 transmits a screen including the alert to the user terminal 20.

In step S303, the UI unit 21 of the user terminal 20 displays a screen including the alert on the display unit 250. FIG. 13 is a diagram illustrating an example of a meeting minutes database management screen displayed on the display unit 250 of the user terminal 20 in step S303. As illustrated in FIG. 13, the screen example G4 includes a name of a document (an example of knowledge constituting meeting minutes) constituting the meeting minutes, a size, an update date (an example of date and time information), and a message. A message associated with the document “A city_meeting minutes_20210111” in which an update date is three or more years ago (an example of alert condition) includes an alert “data of three or more years ago is referenced” The user can perform management such as deletion of an inappropriate document with reference to the output alert. As a result, a situation in which an assembly reply is generated with reference to inappropriate meeting minutes can be reduced.

### (Effects of Information Processing System 1A)

As described above, in the information processing system 1A, a configuration is adopted in which the specific application is an application for generating an assembly reply of a local government, the input information includes a natural language sentence indicating an assembly question, the output information includes a natural language sentence indicating the assembly reply, the first knowledge is knowledge regarding a past assembly reply in the first local government related to the user, and the second knowledge is knowledge regarding a past assembly reply in the second local government different from the first local government. Therefore, according to the information processing system 1A, in addition to the effects obtained by the information processing system 1, an effect is obtained in that a highly accurate assembly reply adapted to the first local government can be obtained by using the large-scale language model fine-tuned for the application of creating an assembly reply even for the first local government that is difficult to perform fine-tuning.

Furthermore, in the information processing system 1A, a plurality of large-scale language models are provided and a user information acquisition unit 15 for acquiring user information relating to the user is further provided, and the model selection unit 12 adopts a configuration of changing a selectable large-scale language model among the plurality of large-scale language models according to the user information. Therefore, according to the information processing system 1A, in addition to the effects obtained by the information processing system 1, effects are obtained in that a model corresponding to the user information among fine-tuned large-scale language models can be used, and that output information adapted to the user information can be obtained.

Furthermore, the information processing system 1A further includes the conversion unit 16 for converting the data format of the first knowledge, and the relevant knowledge acquisition unit 13 is configured to acquire the relevant knowledge from the converted first knowledge. Therefore, according to the information processing system 1A, in addition to the effects obtained by the information processing system 1, effects can be obtained in that the first knowledge can be converted into a data format suitable for acquiring the relevant knowledge, and that the accuracy of the relevant knowledge to be referred to can be improved and the calculation cost related to the relevant knowledge acquisition processing can be reduced.

Furthermore, in the information processing system 1A, the output information generation unit 14 has a configuration of including information indicating the relevant knowledge in the output information. Therefore, according to the information processing system 1A, in addition to the effects obtained by the information processing system 1, it is possible to cause the user to recognize what kind of relevant knowledge has been referred to by the large-scale language model in order to generate a natural language sentence in a specific application. Furthermore, an effect that the user can consider the generated natural language sentence in view of such referred relevant knowledge is obtained.

Furthermore, the information processing system 1A further includes the evaluation acquisition unit 17 for acquiring the evaluation of the user with respect to the relevant knowledge included in the output information, and the relevant knowledge acquisition unit 13 is configured to acquire the relevant knowledge relevant to the new input information based on the first knowledge and the evaluation. For this reason, according to the information processing system 1A, in addition to the effect obtained by the information processing system 1, since the relevant knowledge acquired according to the evaluation of the user is referred to in the next and subsequent times, an effect is obtained in that more highly accurate output information adapted to each user can be obtained.

In addition, the information processing system 1A has a configuration of further including the alert output unit 18 configured to output an alert regarding knowledge satisfying a predetermined alert condition among the respective knowledge constituting the first knowledge. Therefore, according to the information processing system 1A, in addition to the effect obtained by the information processing system 1, effects are obtained in that whether to exclude the knowledge to which the alert has been output can be considered, and a situation in which the output information is referred to with reference to inappropriate relevant knowledge can be reduced.

### (Modified Example)

In the present example embodiment, as a specific application, other applications may be applied instead of creating an assembly reply and generating an answer of an in-office Q&A. Furthermore, other users may be applied as the user instead of the local government. In addition, the first knowledge and the second knowledge are not limited to the meeting minutes and the past in-office Q&A, and various kinds of knowledge that can be referred to in specific applications can be applied.

### Example of Implementation by Software

Some or all of the functions of each of the devices (hereinafter, also described as “each of the above devices”) constituting the information processing system 1 and 1A may be implemented by hardware such as an integrated circuit (IC chip) or may be implemented by software.

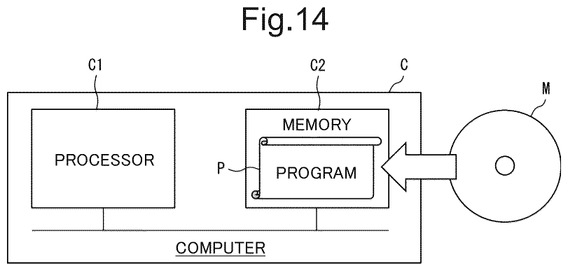

In the latter case, each of the above devices is implemented by, for example, a computer that executes a command of a program that is software for implementing each function. An example of such a computer (hereinafter, referred to as a computer C) is illustrated in FIG. 14. FIG. 14 is a block diagram illustrating a hardware configuration of the computer C functioning as each of the devices.

The computer C includes at least one processor C1 and at least one memory C2. A program P causing the computer C to operate as each of the above devices is recorded in the memory C2. In the computer C, the processor C1 reads the program P from the memory C2 and executes the program P to implement each function of each of the above devices.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a non-transitory recording medium M, for example, a tape, a disk, a card, a semiconductor memory, a programmable logic circuit, or the like can be used.

The computer C can acquire the program P via such a non-transitory recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by one processor provided in one computer, may be implemented in cooperation with a plurality of processors provided in one computer, or may be implemented in cooperation with a plurality of processors provided in a plurality of computers, respectively. The program causing each of the above devices to implement each of the above functions may be stored in one memory provided in one computer, may be stored in a distributed manner in a plurality of memories provided in one computer, or may be stored in a distributed manner in a plurality of memories provided in a plurality of computers, respectively.

### Supplementary Note A

The present disclosure includes techniques described in the following supplementary notes. However, the present disclosure is not limited to the techniques described in the following supplementary notes, and various modifications can be made within the scope described in the claims.

### (Supplementary Note A1)

An information processing system including:
an input information acquisition means for acquiring input information including a natural language sentence input by a user to obtain a natural language sentence based on a first knowledge in a specific application,
a model selection means for selecting, from one or a plurality of large-scale language models, a tuning model that is a large-scale language model fine-tuned using a second knowledge different from the first knowledge in the specific application,
a relevant knowledge acquisition means for acquiring relevant knowledge relevant to the input information from the first knowledge, and
an output information generation means for generating output information including a natural language sentence according to the relevant knowledge and the input information by using the tuning model.

### (Supplementary Note A2)

The information processing system according to supplementary note A1, in which
the specific application is an application for generating an assembly reply of a local government,
the input information includes a natural language sentence indicating an assembly question,
the output information includes a natural language sentence indicating an assembly reply,
the first knowledge is a knowledge regarding a past assembly reply in a first local government related to the user, and
the second knowledge is a knowledge regarding a past assembly reply in a second local government different from the first local government.

### (Supplementary Note A3)

The information processing system according to supplementary note A1 or A2, in which
multiple large-scale language models are provided,
a user information acquisition means for acquiring user information regarding the user is further provided, and
the model selection means changes a selectable large-scale language model among the plurality of large-scale language models according to the user information.

### (Supplementary Note A4)

The information processing system according to any one of supplementary notes A1 to A3, further including:
a conversion means for converting a data format of the first knowledge, in which
the relevant knowledge acquisition means acquires the relevant knowledge from the converted first knowledge.
   (supplementary Note A5)

The information processing system according to any one of supplementary notes A1 to A4, in which the output information generation means includes information indicating the relevant knowledge in the output information.

### (Supplementary Note A6)

The information processing system according to supplementary note A5, further including:
an evaluation acquisition means for acquiring evaluation of the user with respect to the relevant knowledge included in the output information, in which
the relevant knowledge acquisition means acquires relevant knowledge relevant to new input information based on the first knowledge and the evaluation.

### (Supplementary Note A7)

The information processing system according to any one of supplementary notes A1 to A6, further including an alert output means for outputting an alert regarding a knowledge satisfying a predetermined alert condition among the knowledge constituting the first knowledge.

### Supplementary Note B

The present disclosure includes techniques described in the following supplementary notes. However, the present disclosure is not limited to the techniques described in the following supplementary notes, and various modifications can be made within the scope described in the claims.

### (Supplementary Note B1)

An information processing method including:
an input information acquisition processing in which at least one processor acquires input information including a natural language sentence input by a user to obtain a natural language sentence based on a first knowledge in a specific application,
a model selection processing in which the at least one processor selects, from one or a plurality of large-scale language models, a tuning model that is a large-scale language model fine-tuned using a second knowledge different from the first knowledge in the specific application,
a relevant knowledge acquisition processing in which the at least one processor acquires relevant knowledge relevant to the input information from the first knowledge, and
an output information generation processing in which the at least one processor generates output information including a natural language sentence according to the relevant knowledge and the input information by using the tuning model.

### (Supplementary Note B2)

The information processing method according to supplementary note B1, in which
the specific application is an application for generating an assembly reply of a local government,
the input information includes a natural language sentence indicating an assembly question,
the output information includes a natural language sentence indicating an assembly reply,
the first knowledge is a knowledge regarding a past assembly reply in a first local government related to the user, and
the second knowledge is a knowledge regarding a past assembly reply in a second local government different from the first local government.

### (Supplementary Note B3)

The information processing method according to supplementary note B1 or B2, in which
multiple large-scale language models are provided,
a user information acquisition processing in which the at least one processor acquires user information regarding the user is further provided, and
in the model selection processing, the at least one processor changes a selectable large-scale language model among the plurality of large-scale language models according to the user information.
   (supplementary Note B4)

The information processing method according to any one of supplementary notes B1 to B3, further including:
a conversion processing in which the at least one processor converts a data format of the first knowledge, in which
in the relevant knowledge acquisition processing, the at least one processor acquires the relevant knowledge from the converted first knowledge.

### (Supplementary Note B5)

The information processing method according to any one of supplementary notes B1 to B4, in which in the output information generation processing, the at least one processor includes information indicating the relevant knowledge in the output information.

### (Supplementary Note B6)

The information processing method according to supplementary note B5, further including:
an evaluation acquisition processing in which the at least one processor acquires an evaluation of the user with respect to the relevant knowledge included in the output information, in which
in the relevant knowledge acquisition processing, the at least one processor acquires relevant knowledge relevant to new input information based on the first knowledge and the evaluation.

### (Supplementary Note B7)

The information processing method according to any one of supplementary notes B1 to B6, further including an alert output processing in which the at least one processor outputs an alert regarding a knowledge satisfying a predetermined alert condition among the knowledge constituting the first knowledge.

### Supplementary Note C

The present disclosure includes techniques described in the following supplementary notes. However, the present disclosure is not limited to the techniques described in the following supplementary notes, and various modifications can be made within the scope described in the claims.

### (Supplementary Note C1)

An information processing program for causing a computer to function as an information processing system, the information processing program causing the computer to function as:
an input information acquisition means for acquiring input information including a natural language sentence input by a user to obtain a natural language sentence based on a first knowledge in a specific application,
a model selection means for selecting, from one or a plurality of large-scale language models, a tuning model that is a large-scale language model fine-tuned using a second knowledge different from the first knowledge in the specific application,
a relevant knowledge acquisition means for acquiring relevant knowledge relevant to the input information from the first knowledge, and
an output information generation means for generating output information including a natural language sentence according to the relevant knowledge and the input information by using the tuning model.

### (Supplementary Note C2)

The information processing program according to supplementary note C1, in which
the specific application is an application for generating an assembly reply of a local government,
the input information includes a natural language sentence indicating an assembly question,
the output information includes a natural language sentence indicating an assembly reply,
the first knowledge is a knowledge regarding a past assembly reply in a first local government related to the user, and
the second knowledge is a knowledge regarding a past assembly reply in a second local government different from the first local government.

### (Supplementary Note C3)

The information processing program according to supplementary note C1 or C2, in which
multiple large-scale language models are provided,
the computer is further caused to function as a user information acquisition means for acquiring user information regarding the user, and
the model selection means changes a selectable large-scale language model among the plurality of large-scale language models according to the user information.

### (Supplementary Note C4)

The information processing program according to any one of supplementary notes C1 to C3, further causing:
the computer to function as a conversion means for converting a data format of the first knowledge, in which
the relevant knowledge acquisition means acquires the relevant knowledge from the converted first knowledge.

### (Supplementary Note C5)

The information processing program according to any one of supplementary notes C1 to C4, in which the output information generation means includes information indicating the relevant knowledge in the output information.

### (Supplementary Note C6)

The information processing program according to supplementary note C5, further causing:
the computer to function as an evaluation acquisition means for acquiring evaluation of the user with respect to the relevant knowledge included in the output information, in which
the relevant knowledge acquisition means acquires relevant knowledge relevant to new input information based on the first knowledge and the evaluation.

### (Supplementary Note C7)

The information processing program according to any one of supplementary notes C1 to C6, further causing the computer to function as an alert output means for outputting an alert regarding a knowledge satisfying a predetermined alert condition among the knowledge constituting the first knowledge.

### Supplementary Note D

The present disclosure includes techniques described in the following supplementary notes. However, the present disclosure is not limited to the techniques described in the following supplementary notes, and various modifications can be made within the scope described in the claims.

### (Supplementary Note D1)

An information processing system including at least one processor, in which the at least one processor executes,
an input information acquisition processing of acquiring input information including a natural language sentence input by a user to obtain a natural language sentence based on a first knowledge in a specific application,
a model selection processing of selecting, from one or a plurality of large-scale language models, a tuning model that is a large-scale language model fine-tuned using a second knowledge different from the first knowledge in the specific application,
a relevant knowledge acquisition processing of acquiring relevant knowledge relevant to the input information from the first knowledge, and
an output information generation processing of generating output information including a natural language sentence according to the relevant knowledge and the input information by using the tuning model.

The information processing system may further include a memory. The memory may store a program for causing the at least one processor to execute each of the processing.

### (Supplementary Note D2)

The information processing system according to supplementary note D1, in which
the specific application is an application for generating an assembly reply of a local government,
the input information includes a natural language sentence indicating an assembly question,
the output information includes a natural language sentence indicating an assembly reply,
the first knowledge is a knowledge regarding a past assembly reply in a first local government related to the user, and
the second knowledge is a knowledge regarding a past assembly reply in a second local government different from the first local government.

### (Supplementary Note D3)

The information processing system according to supplementary note D1 or D2, in which
multiple large-scale language models are provided,
the at least one processor further executes a user information acquisition processing of acquiring user information regarding the user, and
in the model selection processing, the at least one processor model changes a selectable large-scale language model among the plurality of large-scale language models according to the user information.

### (Supplementary Note D4)

The information processing system according to any one of supplementary notes D1 to D3, in which
the at least one processor further executes a conversion processing of converting a data format of the first knowledge, and
in the relevant knowledge acquisition processing, the at least one processor acquires the relevant knowledge from the converted first knowledge.

### (Supplementary Note D5)

The information processing system according to any one of supplementary notes D1 to D4, in which in the output information generation processing, the at least one processor includes information indicating the relevant knowledge in the output information.

### (Supplementary Note D6)

The information processing system according to supplementary note D5, in which,
the at least one processor further executes an evaluation acquisition processing of acquiring an evaluation of the user with respect to the relevant knowledge included in the output information, and
in the relevant knowledge acquisition processing, the at least one processor acquires relevant knowledge relevant to new input information based on the first knowledge and the evaluation.

### (Supplementary Note D7)

The information processing system according to any one of supplementary notes D1 to D6, in which the at least one processor further executes an alert output processing of outputting an alert regarding a knowledge satisfying a predetermined alert condition among the knowledge constituting the first knowledge.

### Supplementary Note E

The present disclosure includes techniques described in the following supplementary note. However, the present disclosure is not limited to the techniques described in the following supplementary note, and various modifications can be made within the scope described in the claims.

### (Supplementary Note E1)

A non-transitory recording medium recorded with an information processing program for causing a computer to function as an information processing system, the information processing program causing the computer to execute:
an input information acquisition processing of acquiring input information including a natural language sentence input by a user to obtain a natural language sentence based on a first knowledge in a specific application,
a model selection processing of selecting, from one or a plurality of large-scale language models, a tuning model that is a large-scale language model fine-tuned using a second knowledge different from the first knowledge in the specific application,
a relevant knowledge acquisition processing of acquiring relevant knowledge relevant to the input information from the first knowledge, and
an output information generation processing of generating output information including a natural language sentence according to the relevant knowledge and the input information by using the tuning model.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing system comprising:
one or more memories storing instructions; and
one or more processors configured to execute the instructions to:
acquire input information including a natural language sentence input by a user to obtain a natural language sentence based on a first knowledge in a specific application;
select, from one or a plurality of large-scale language models, a tuning model that is a large-scale language model fine-tuned using a second knowledge different from the first knowledge in the specific application;
acquire relevant knowledge relevant to the input information from the first knowledge; and
generate output information including a natural language sentence according to the relevant knowledge and the input information by using the tuning model.

2. The information processing system according to claim 1, wherein
the specific application is an application for generating an assembly reply of a local government;
the input information includes a natural language sentence indicating an assembly question;
the output information includes a natural language sentence indicating an assembly reply;
the first knowledge is a knowledge regarding a past assembly reply in a first local government related to the user; and
the second knowledge is a knowledge regarding a past assembly reply in a second local government different from the first local government.

3. The information processing system according to claim 1, wherein
multiple large-scale language models are provided; and
the one or more processors are configured to execute the instructions to:
further acquire user information regarding the user; and
change a selectable large-scale language model among the plurality of large-scale language models according to the user information.

4. The information processing system according to claim 1, wherein the one or more processors are configured to execute the instructions to:
further convert a data format of the first knowledge; and
acquire the relevant knowledge from the converted first knowledge.

5. The information processing system according to claim 1, wherein the one or more processors are configured to execute the instructions to include information indicating the relevant knowledge in the output information.

6. The information processing system according to claim 5, wherein
the one or more processors are configured to execute the instructions to:
further acquire evaluation of the user with respect to the relevant knowledge included in the output information; and
acquire relevant knowledge relevant to new input information based on the first knowledge and the evaluation.

7. The information processing system according to claim 1, wherein the one or more processors are further configured to execute the instructions to output an alert regarding a knowledge satisfying a predetermined alert condition among the knowledge constituting the first knowledge.

8. An information processing method comprising:
by a computer,
acquiring input information including a natural language sentence input by a user to obtain a natural language sentence based on a first knowledge in a specific application,
selecting, from one or a plurality of large-scale language models, a tuning model that is a large-scale language model fine-tuned using a second knowledge different from the first knowledge in the specific application,
acquiring relevant knowledge relevant to the input information from the first knowledge, and
generating output information including a natural language sentence according to the relevant knowledge and the input information by using the tuning model.

9. A non-transitory recording medium recorded with an information processing program for causing a computer to function as an information processing system, the information processing program causing the computer to execute:
acquiring input information including a natural language sentence input by a user to obtain a natural language sentence based on a first knowledge in a specific application,
selecting, from one or a plurality of large-scale language models, a tuning model that is a large-scale language model fine-tuned using a second knowledge different from the first knowledge in the specific application,
acquiring relevant knowledge relevant to the input information from the first knowledge, and
generating output information including a natural language sentence according to the relevant knowledge and the input information by using the tuning model.
